(19) United States
(12) Patent Application Publication
(10) Pub. No.: US 2024/0277049 A1
(43) Pub. Date: Aug. 22, 2024

(54) AEROSOL GENERATING DEVICE

(71) Applicant: KT&G CORPORATION, Daejeon (KR)

(72) Inventor: Taehun KIM, Yongin-si Gyeonggi-do (KR)

(73) Assignee: KT&G CORPORATION, Daejeon (KR)

(21) Appl. No.: 18/291,175

(22) PCT Filed: Aug. 16, 2022
(86) PCT No.: PCT/KR2022/012176

§ 371 Date: Jan. 22, 2024

(30) Foreign Application Priority Data
Aug. 17, 2021 (KR) 10-2021-0108213

(51) Int. Cl. A24F 40/40; A24F 40/70

(52) U.S. Cl. CPC A24F 40/40; A24F 40/70

(57) ABSTRACT

An aerosol generating device is provided. The aerosol generating device includes: a body comprising a pin hole; a pin coupled to a pin housing and configured to provide electrical power for generating the aerosol, wherein the pin housing is disposed adjacent to the pin hole such that the pin is inserted through the pin hole toward an outside of the body; and a plate coupled to the pin housing and the body and configured to seal a connection between the body and the pin housing.

### TECHNICAL FIELD

The present disclosure relates to an aerosol generating device.

### BACKGROUND ART

An aerosol generating device is a device that extracts certain components from a medium or a substance by creating an aerosol. The medium may contain a variety of substances. A substance contained in the medium may be a multicomponent flavoring substance. For example, the substance contained in the medium may include a nicotine component, an herbal component and/or a coffee component. Recently, various research on aerosol generating devices has been conducted.

### DISCLOSURE OF INVENTION

### Technical Problem

It is an objective of the present disclosure to solve the above and other problems.

It is another objective of the present disclosure to seal a gap around a terminal that supplies power to a cartridge and to prevent the inflow of a liquid, a foreign substance, and the like.

It is yet another objective of the present disclosure to provide a structure for securely supporting a terminal.

It is yet another objective of the present disclosure to facilitate contact with a terminal when a cartridge is coupled to a device.

It is yet another objective of the present disclosure to facilitate the manufacture of a sealing structure around a terminal.

### Solution to Problem

According to an aspect of the subject matter described in this application, an aerosol generating device includes: a body comprising a pin hole; a pin coupled to a pin housing and configured to provide electrical power for generating the aerosol, wherein the pin housing is disposed adjacent to the pin hole such that the pin is inserted through the pin hole toward an outside of the body; and a plate coupled to the pin housing and the body and configured to seal a connection between the body and the pin housing.

### Advantageous Effects of Invention

According to at least one of the embodiments of the present disclosure, a gap around a terminal that supplies power to a cartridge may be sealed, and the inflow of a liquid, a foreign substance, and the like may be prevented.

According to at least one of the embodiments of the present disclosure, a structure that securely supports a terminal may be provided.

According to at least one of the embodiments of the present disclosure, contact with a terminal may be facilitated when a cartridge is coupled to a device.

According to at least one of the embodiments of the present disclosure, the manufacture of a sealing structure around a terminal may be facilitated.

Further scope of applicability of the present disclosure will become apparent from the following detailed description. However, it should be understood that the detailed description and specific embodiments such as preferred embodiments of the present disclosure are given by way of example only, since various changes and modifications within the idea and scope of the present disclosure may be clearly understood by those skilled in the art.

### BRIEF DESCRIPTION OF DRAWINGS

FIGS. 1 to 20 are diagrams illustrating examples of an aerosol generating device according to embodiments of the present disclosure.

### MODE FOR THE INVENTION

Description will now be given in detail according to exemplary embodiments disclosed herein, with reference to the accompanying drawings. For the sake of brief description with reference to the drawings, the same or equivalent components are provided with the same or similar reference numbers, and description thereof will not be repeated.

In the following description, a suffix such as “module” and “unit” may be used to refer to elements or components. Use of such a suffix herein is merely intended to facilitate description of the specification, and the suffix itself is not intended to give any special meaning or function.

In the present disclosure, that which is well known to one of ordinary skill in the relevant art has generally been omitted for the sake of brevity. The accompanying drawings are used to help easily understand the technical idea of the present disclosure and it should be understood that the idea of the present disclosure is not limited by the accompanying drawings. The idea of the present disclosure should be construed to extend to any alterations, equivalents and substitutes besides the accompanying drawings.

It will be understood that although the terms first, second, etc. may be used herein to describe various elements, these elements should not be limited by these terms. These terms are only used to distinguish one element from another.

It will be understood that when an element is referred to as being “connected with” another element, there may be intervening elements present. In contrast, it will be understood that when an element is referred to as being “directly connected with” another element, there are no intervening elements present.

A singular representation may include a plural representation unless context clearly indicates otherwise.

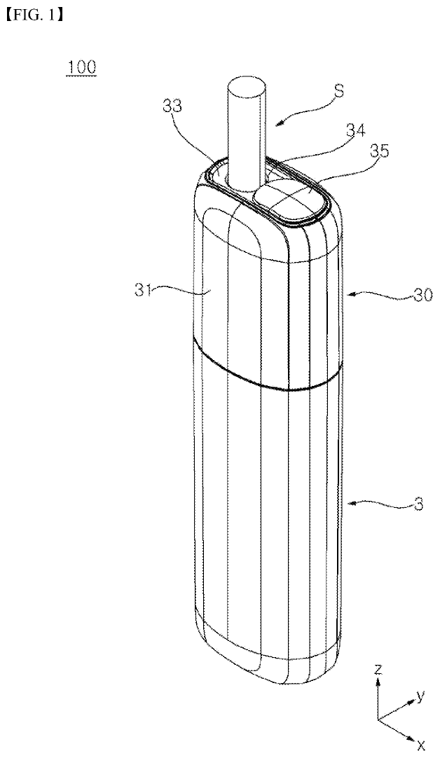

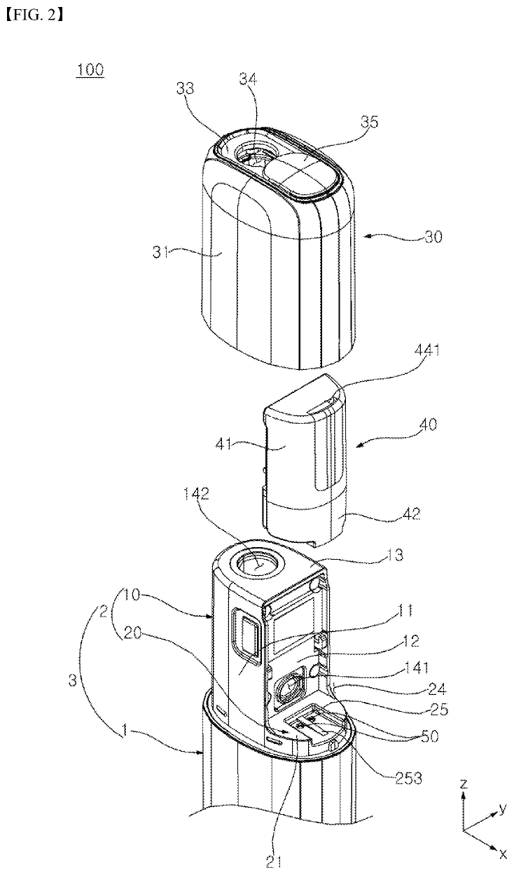

Referring to FIGS. 1 and 2, an aerosol generating device 100 may include a body 3. The aerosol generating device 100 may include a cap 30. The aerosol generating device 100 may include a cartridge 40. The cartridge 40 may be detachably coupled to one side of the body 3. The cap 30 may be detachably coupled to the body 3 to cover the cartridge 40. A stick S may penetrate through the cap 30 to be inserted into the body 3.

The body 3 may include a lower body 1 and an upper body 2. Components of the aerosol generating device 100, such as a battery, a controller, and the like, may be installed in the lower body 1. The upper body 2 may be coupled to an upper side of the lower body 1.

The upper body 2 may include a column 10 and a seating part 20. The column 10 may extend in an up-and-down direction or vertically in an elongated manner. The column 10 may include an outer wall 11, an inner wall 12, and an upper wall 13.

The seating part 20 may protrude from a lower portion of the inner wall 12 of the column 10. The seating part 20 may face upward. A cartridge region 24 may be formed between the inner wall 12 of the column 10 and the seating part 20. The cartridge region 24 may be disposed on one side of the inner wall 12 of the column 10, and may be disposed on an upper side of the seating part 20.

The column 10 may include an insertion space 142. The insertion space 142 may extend vertically in the column 10, and may be open upward to allow the upper wall 13 to be open.

A body inlet 141 may be formed at one side of the column 10. The inner wall 12 may be open to define the body inlet 141. The body inlet 141 may be open to an outside of the column 10. The body inlet 141 may communicate with the insertion space 142. The body inlet 141 may be disposed to face the cartridge region 24. The body inlet 141 may communicate with the cartridge region 24.

The cartridge 40 may be detachably coupled to the upper body 2 at the cartridge region 24. The cartridge 40 may be coupled to the inner wall 12 of the column 10, and may be placed or seated on the seating part 20 to thereby allow a bottom of the cartridge 40 to be supported. The cartridge 40 may include a first container 41 and a second container 42. The first container 41 may be disposed on the second container 42. The first container 41 may store a liquid therein.

The cap 30 may be detachably coupled to the body 3 while covering the upper body 2. The cap 30 may cover the upper body 2 and the cartridge 40 that is coupled to the upper body 2. The cap 30 may be provided therein with a space into which the upper body 2 and the cartridge 40 are inserted. The inner space of the cap 30 may be open downward. A sidewall 31 of the cap 30 may surround a side portion of the inner space of the cap 30. An upper wall 33 of the cap 30 may cover an upper portion of the inner space of the cap 30. The upper wall 33 may be open to define an insertion hole 34. When the cap 30 is coupled to the body 3, the insertion hole 34 may communicate with the insertion space 142 at an upper side of the insertion space 142. A cover 35 may be movably installed on the upper wall 33. The cover 35 may slide on the upper wall 33. The cover 35 may open and close the insertion hole 34.

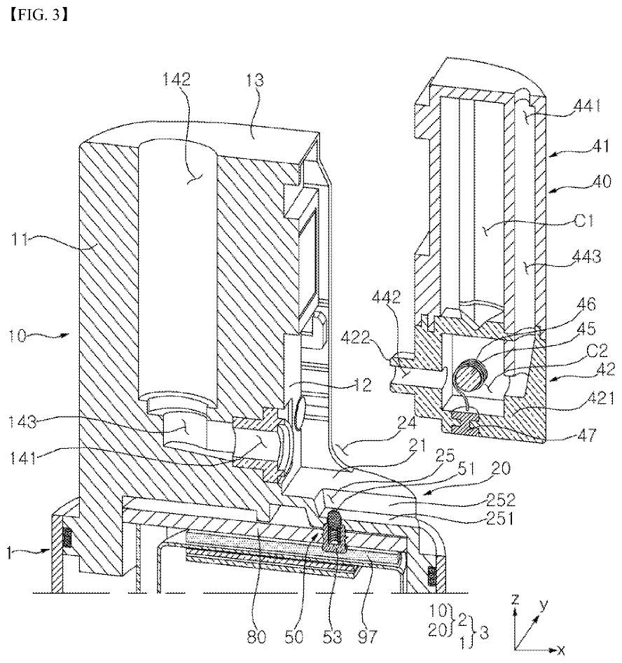

Referring to FIG. 3, a first chamber C1 may be formed in the first container 41. A liquid may be stored in the first chamber C1. A second chamber C2 may be formed in the second container 42.

The cartridge 40 may be open to define a cartridge inlet 441. The cartridge 40 may be open to define a cartridge outlet 442. A cartridge flow path 443 may connect the cartridge inlet 441 and the second chamber C2. The cartridge outlet 442 may communicate with the second chamber C2.

One side of the second container 42 may be open to define the cartridge outlet 442. An outlet port 422 may surround the cartridge outlet 442. The outlet port 422 may protrude from the one side of the second container 42. When the cartridge 40 is coupled to the upper body 2, the outlet port 422 may be inserted into the body inlet 141, allowing the cartridge outlet 442 and the body inlet 141 to communicate with each other.

A wick 45 may be installed at the second chamber C2. The wick 45 may be connected to the first chamber C1. The wick 45 may receive a liquid from the first chamber C1. A heater 46 may generate heat to heat the wick 45. The heater 46 may be disposed at the second chamber C2. The heater 46 may be wound around the wick 45. When the wick 45 is heated by the heater 46, an aerosol may be produced near the wick 45 in the second chamber C2.

A heater terminal 47 may be exposed to a lower portion of the cartridge 40. The heater terminal 47 may be provided at a bottom of the second container 42. The heater terminal 47 may be electrically connected to the heater 46. When the cartridge 40 is coupled to the upper body 2, the heater terminal 47 may be brought into contact with a first pin 50, allowing the heater 46 to be electrically connected to a power source in the lower body 1. The heater terminal 47 may also be referred to as a second pin 47.

The first pin 50 may protrude outside the seating part 20. The first pin 50 may receive, through a connector 97, power from a battery installed in the lower body 1 to thereby provide the power to the heater terminal 47 and the heater 46. The power supplied to the heater 46 may allow the heater 46 to generate heat.

Air at an outside of the cartridge 40 may be introduced into the cartridge 40 through the cartridge inlet 441. The air may sequentially flow through the cartridge inlet 441, the cartridge flow path 443, the second chamber C2, and the cartridge outlet 442. Air at an inside of the cartridge 40 may be discharged, through the cartridge outlet 442, to the outside of the cartridge 40. Air introduced into the cartridge 40, together with an aerosol generated in the second chamber C2, may be discharged to the outside of the cartridge 40 through the cartridge outlet 442.

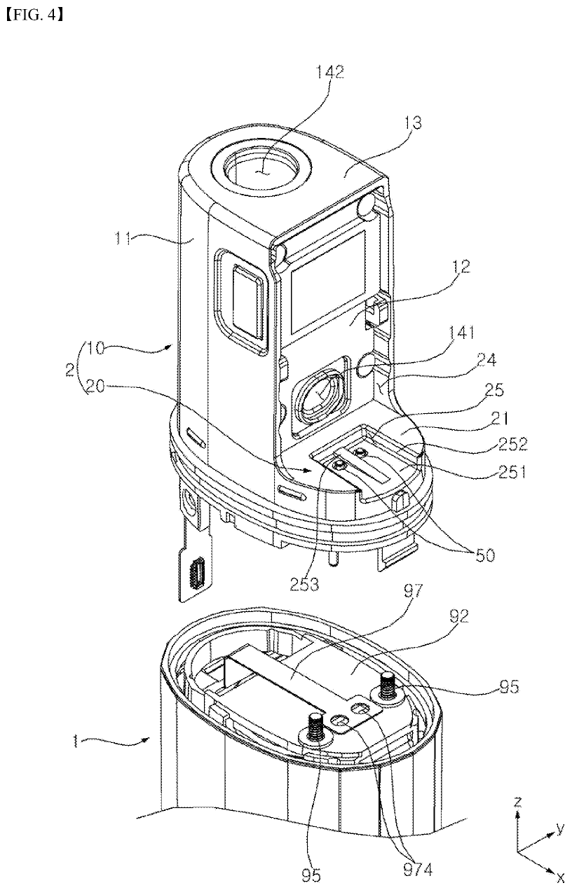

Referring to FIGS. 3 and 4, the first pin 50 may be disposed at an inside of the body 3, and may protrude outside the body 3. The body 3 may include the seating part 20.

The seating part 20 may include an outer recessed groove 25. An upper surface 21 of the seating part 20 may be recessed downward to define the outer recessed groove 25. The outer recessed groove 25 may be disposed at a lower side of the cartridge region 24.

A lower portion of the outer recessed groove 25 may be covered by a bottom portion 251, and a side portion of the outer recessed groove 25 may be covered by a peripheral portion 252. An upper side of the outer recessed groove 25 may be open. One side portion of the outer recessed groove 25 may be open without being covered by the peripheral portion 252. When a x-direction shown in a coordinate system is referred to as a front direction, a front side of the outer recessed groove 25 may be open. An upper end of the first pin 50 may be exposed upward or convexly protrude upward from the bottom portion 251 of the outer recessed groove 25 toward the outer recessed groove 25.

A guide portion 253 may protrude upward from a bottom of the outer recessed groove 25. The guide portion 253 may be disposed between a pair of first pins 50 protruding to the outer recessed groove 25. The guide portion 253 may extend long from the front to the rear. As the guide portion 253 extends from the front to the rear, the guide portion 253 may pass between the pair of first pins 50. The guide portion 253 may be inclined such that the guide portion 253 becomes steeper toward the rear.

The bottom of the cartridge 40 may have a shape corresponding to the seating part 20 and the outer recessed groove 25. The bottom of the cartridge 40 may be recessed upward to correspond to a position/shape of the guide portion 253. When the cartridge 40 is coupled to the upper body 2, the guide portion 253 may guide placement of the cartridge 40 to allow the first pin 50 and the second pin 47 to be in contact with each other. When the cartridge 40 is coupled to the upper body 2, the bottom of the cartridge 40 may be placed on the seating part 20, allowing the first pin 50 and the second pin 47 to be electrically connected to each other.

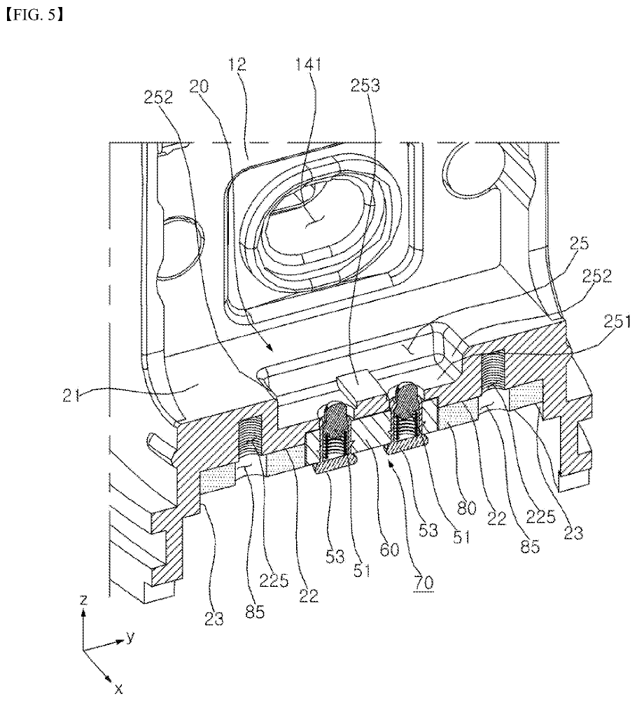

Referring to FIGS. 4 and 5, the first pin 50 may be coupled to a first molding member 60. Upper and lower ends of the first pin 50 may protrude vertically from the first molding member 60. The first molding member 60 may be disposed on a lower side of the seating part 20 and the outer recessed groove 25. The first molding member 60 may be referred to as a first block 60 or a pin housing 60.

A second molding member 80 may be coupled to the body 3 and the first molding member 60. The second molding member 80 may cover or seal between the body 3 and the first molding member 60. The second molding member 80 may be coupled to a lower surface 22 of the seating part 20. The second molding member 80 may be referred to as a second block 80 or a plate 80.

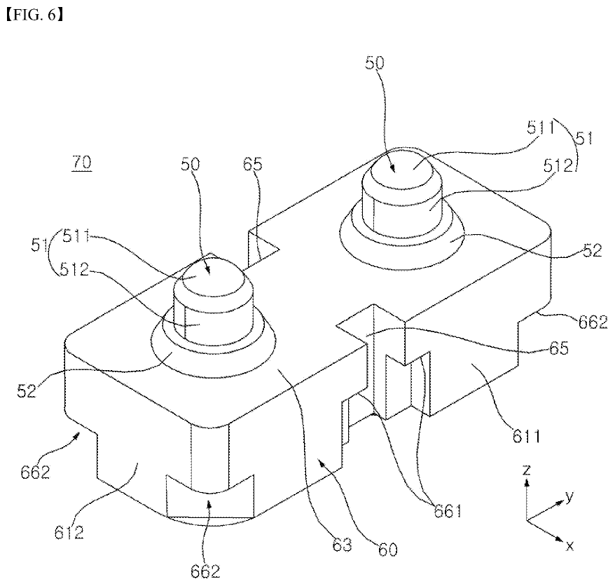

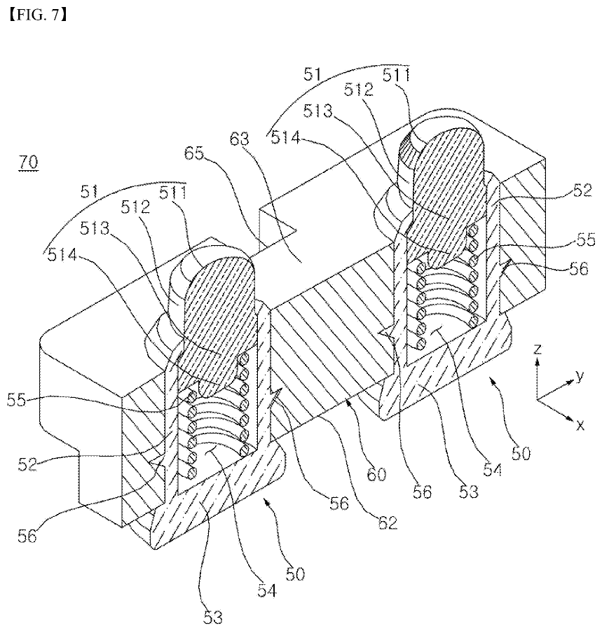

Referring to FIGS. 6 and 7, a pin assembly 70 may include at least one first pin 50 and the first molding member 60. The first pin 50 and the first molding member 60 may be coupled to each other. The first molding member 60 may be insert-injected into the first pin 50. For example, the first molding member 60 may be formed by placing the first pin 50 in a mold for insert injection molding, injecting a molten injection molding material into the mold, and then cooling and hardening. The first molding member 60 may be in close contact with the first pin 50. The first pin 50 may be provided in pair. The pair of first pins 50 may be spaced apart from each other by a predetermined distance.

The first pin 50 may be a pogo pin. The first pin 50 may include a top plunger 51. The first pin 50 may include a barrel 52. The first pin 50 may include a bottom plunger 53.

The top plunger 51 may be disposed at an upper portion of the first pin 50. A lower portion of the top plunger 51 may be inserted into the barrel 52. An upper portion of the top plunger 51 may protrude upward from the barrel 52. The top plunger 51 may be movable in the barrel 52 in the up-and-down direction.

The top plunger 51 may include a head portion 511. The top plunger 51 may include a body portion 512. The top plunger 51 may include a stopper portion 513. The head portion 511 may be formed at an upper end of the first pin 50. The head portion 511 may be formed on the body portion 512. The head portion 511 may convexly protrude upward from the body portion 512. The head portion 511 may have a rounded shape. The head portion 511 may include at least a portion of a spherical shape. The head portion 511 may be disposed at an upper side of the barrel 52.

The body portion 512 may have a cylindrical shape. The body portion 512 may have a shape extending downward along an outer circumference of the head portion 511. The body portion 512 may protrude upward from the barrel 52. When the top plunger 51 is pressed to move down, at least a portion of the body portion 512 may be disposed in the barrel 52. When the top plunger 51 is restored and is moved up, the body portion 512 may be disposed at the upper side of the barrel 52.

The stopper portion 513 may protrude radially outward from a circumference of the body portion 512. The stopper portion 513 may be disposed in the barrel 52. As the stopper portion 513 is in contact with the barrel 52, the top plunger 51 may be prevented from being separated from the barrel 52 and moving up.

The top plunger 51 may further include a protrusion 514. The protrusion 514 may protrude downward from the stopper portion 513 to be inserted into a spring 55. Alternatively, the spring 55 may be inserted into the top plunger 51.

The barrel 52 may have a cylindrical shape. The barrel 52 may have a hollow shape, and may be open upward. The spring 55 may be disposed at an inner space 54 of the barrel 52. A lower end of the spring 55 may support the bottom plunger 53, and an upper end of the spring 55 may support the top plunger 51. The spring 55 may provide an upward restoring or elastic force to the top plunger 51.

The bottom plunger 53 may have a disk or disc shape. The bottom plunger 53 may be formed at a lower end of the first pin 50. A bottom of the barrel 52 may be covered by the bottom plunger 53. Alternatively, the bottom plunger 53 may be the bottom of the barrel 52. The bottom plunger 53 may be integrally formed with the barrel 52. The bottom plunger 53 may protrude further radially outward from a lower end of the barrel 52.

A barrel protrusion 56 may protrude radially outward from a circumference of the barrel 52. The barrel protrusion 56 may extend in a circumferential direction along the circumference of the barrel 52. The barrel protrusion 56 may have a ring shape. The barrel protrusion 56 may be integrally formed with the barrel 52.

The first molding member 60 may be coupled to or in close contact with a circumference of a side portion of the barrel 52. The barrel 52 may be inserted into the first molding member 60 to be buried in the first molding member 60. The barrel protrusion 56 may be disposed at an inside of the first molding member 60. An internal force may be acted by the barrel protrusion 56 in the up-and-down direction with respect to the first molding member 60. The barrel protrusion 56 and the first molding member 60 may vertically support each other.

The top plunger 51 protruding upward from the barrel 52 may protrude upward from the first molding member 60. The head portion 511 may protrude upward from the first molding member 60. At least a portion of the body 512 may protrude upward from the first molding member 60. An upper end of the barrel 52 may be exposed upward from the first molding member 60.

The bottom plunger 53 may protrude downward from the first molding member 60, or may be disposed on a lower side of the first molding member 60. The first molding member 60 may be in contact with or caught on an upper end of the bottom plunger 53. The bottom plunger 53 may upwardly support a lower surface 62 of the first molding member 60.

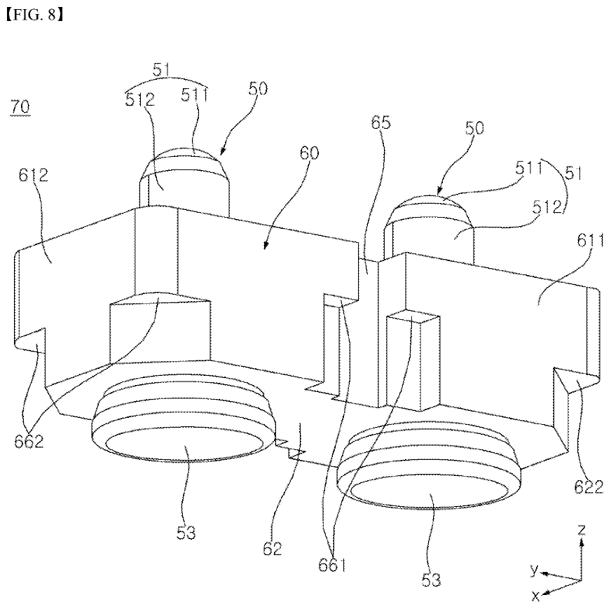

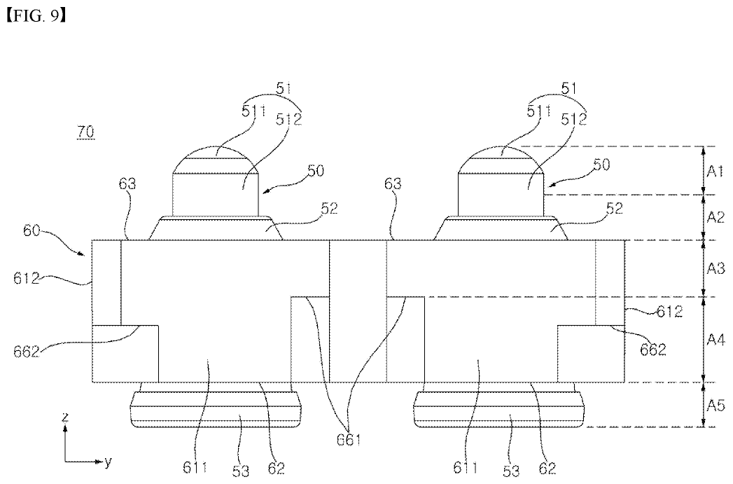

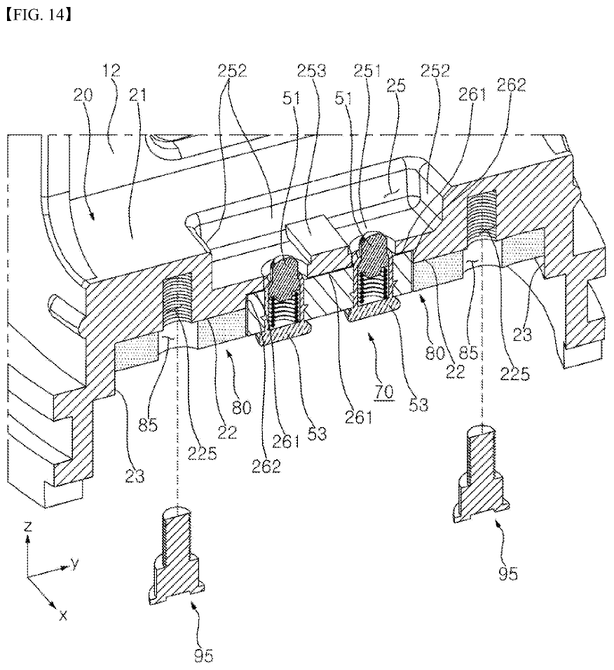

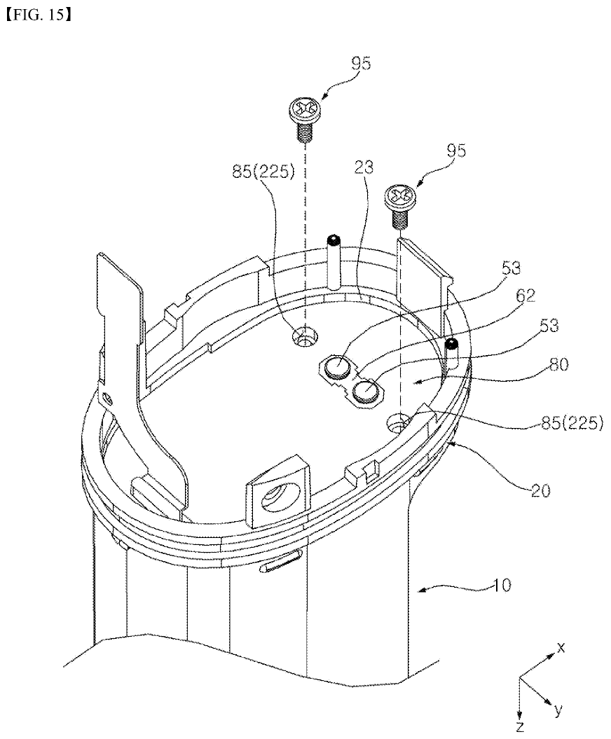

Referring to FIGS. 8 and 9, the first molding member 60 may include a first side surface 611, a second side surface 612, the lower surface 62, and an upper surface 63. The first molding member 60 may include a plurality of grooves formed by recessing a side portion thereof and in which the second molding member 80 (see FIGS. 14 and 15) is filled to be joined together. The first molding member 60 may include a recessed portion 65. The first molding member 60 may include a support surface 661 and a support surface 662.

The recessed portion 65 may be formed such that the first side surface 611 or the second side surface 612 is recessed inward and extends from the lower surface 62 to the upper surface 63. The recessed portion 65 may be formed long in the up-and-down direction. The recessed portion 65 may be open upward and/or downward. The upper surface 63 may not cover an upper side of the recessed portion 65. The lower surface 62 may not cover a lower side of the recessed portion 65. The recessed portion 65 may be disposed adjacent between the pair of first pins 50.

The support surfaces 661 and 662 may each define a surface in a direction intersecting the up-and-down direction. The support surfaces 661 and 662 may face downward. The support surfaces 661 and 662 may be located at a height between the upper surface 63 and the lower surface 62 of the first molding member 60. The lower surface 62 may not cover the support surfaces 661 and 662. The support surfaces 661 and 662 may be formed such that the side surfaces 611 and 612 are recessed inward and extend upward from the lower surface 62 by a predetermined height. The support surfaces 661 and 662 may each be provided in plurality. The first side surface 611 may be recessed inward to define the support surface 661, which is a first support surface 661. A portion between the first side surface 611 and the second side surface 612, or the second side surface 612 may be recessed inward to define the support surface 662, which is a second support surface 662.

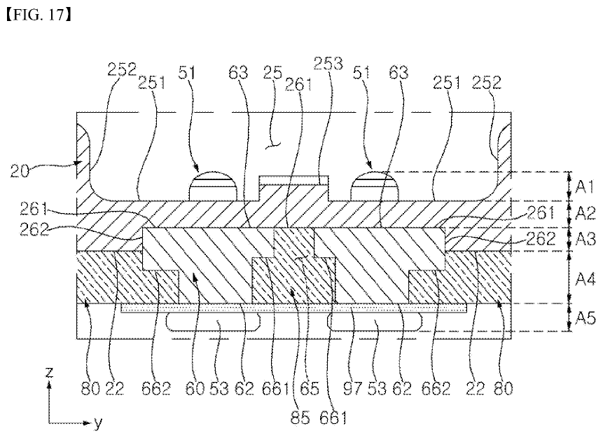

Accordingly, a surface area of the first molding member 60 may be increased. In addition, the support surfaces 661 and 662 vertically supported by the second molding member 80 (see FIG. 17) may be formed.

A first region A1 to a fifth region A5 may be defined vertically with respect to the pin assembly 70. The first region A1 to the fifth region A5 may be sequentially disposed from the top to the bottom of the pin assembly 70.

The first region A1 may be located above the first molding member 60. At least a portion of the top plunger 51 may be disposed in the first region A1. The head portion 511 may be disposed in the first region A1. At least a portion of the body portion 512 may be disposed in the first region A1.

The second region A2 may be located beneath the first region A1. The second region A2 may be disposed on the first molding member 60. At least a portion of the top plunger 51 may be disposed in the second region A2. At least a portion of the body portion 512 may be disposed in the second region A2. The head portion 511 may be disposed at an upper side of the second region A2.

The third region A3 may be located beneath the second region A2. At least a portion of the first molding member 60 may be disposed in the third region A3. An upper portion of the first molding member 60 may be disposed in the third region A3. The upper surface 63 of the first molding member 60 may be disposed on an upper end of the third region A3. An upper portion of the recessed portion 65 may be disposed in the third region A3.

The fourth region A4 may be located beneath the third region A3. At least a portion of the first molding member 60 may be disposed in the fourth region A4. A lower portion of the first molding member 60 may be disposed in the fourth region A4. The lower surface 62 of the first molding member 60 may be disposed on a lower end of the fourth region A4. A lower portion of the recessed portion 65 may be disposed in the fourth region A4.

The support surfaces 661 and 662 may be disposed in the third region A3 to the fourth region A4. The support surfaces 661 and 662 may be disposed between the upper end of the third region A3 and the lower end of the fourth region A4. The first support surface 661 may be disposed in one of the third region A3 and the fourth region A4. The second support surface 662 may be disposed in one of the third region A3 and the fourth region A4.

The fifth region A5 may be located beneath the fourth region A4. The first molding member 60 may be disposed on an upper side of the fifth region A5. At least a portion of the bottom plunger 53 may be disposed in the fifth region A5.

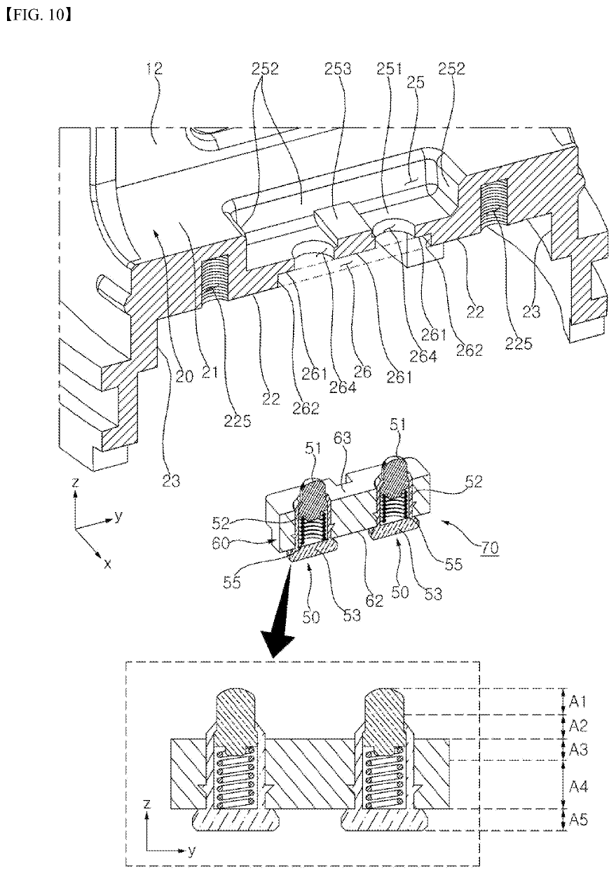

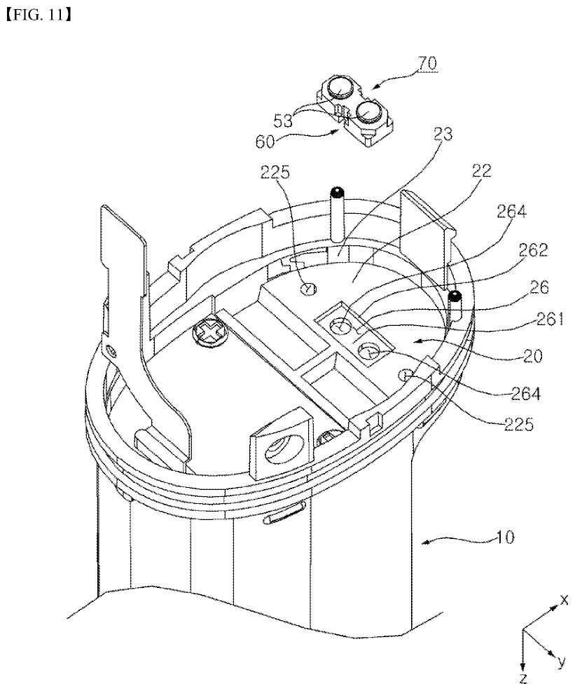

Referring to FIGS. 10 and 11, the seating part 20 may include the outer recessed groove 25 and an inner recessed groove 26. The seating part 20 may include a peripheral portion 23 protruding downward along a circumference of the lower surface 22 of the seating part 20.

The upper surface 21 of the seating part 20 may be recessed downward to define the outer recessed groove 25. The outer recessed groove 25 may be open upward. The outer recessed groove 25 may include the bottom portion 251 and the peripheral portion 252.

The lower surface 22 of the seating part 20 may be recessed upward to define the inner recessed groove 26. The inner recessed groove 26 may be open downward. The outer recessed groove 25 and the inner recessed groove 26 may be disposed opposite each other with respect to the seating part 20. The inner recessed groove 26 may be disposed at a lower side of the outer recessed groove 25. The inner recessed groove 26 may include a bottom portion 261 and a peripheral portion 262.

The seating part 20 may be open in the up-and-down direction to define a pinhole 264. The bottom portion 251 of the outer recessed groove 25 and the bottom portion 261 of the inner recessed groove 26 may be open to define the pinhole 264. The pinhole 264 may be provided in plurality to correspond to the number of first pins 50. The pinhole 264 may be formed between the outer recessed groove 25 and the inner recessed groove 26. The pinhole 264 may communicate with the outer recessed groove 25 and the inner recessed groove 26.

The upper surface 21 of the seating part 20 may also be referred to as an outer surface of the body 3. The lower surface 22 of the seating part 20 may also be referred to as an inner surface of the body 3. The outer recessed groove 25 may be formed on the outer surface of the body 3. The inner recessed groove 26 may be formed on the inner surface of the body 3.

The outer surface of the body 3 may include at least one of the upper surface 21 of the seating part 20, the outer recessed groove 25, and the bottom portion 251 and the peripheral portion 252 of the outer recessed groove 25. The inner surface of the body 3 may include at least one of the lower surface 22 of the seating part 20, the inner recessed groove 26, and the bottom portion 261 and the peripheral portion 262 of the inner recessed groove 26.

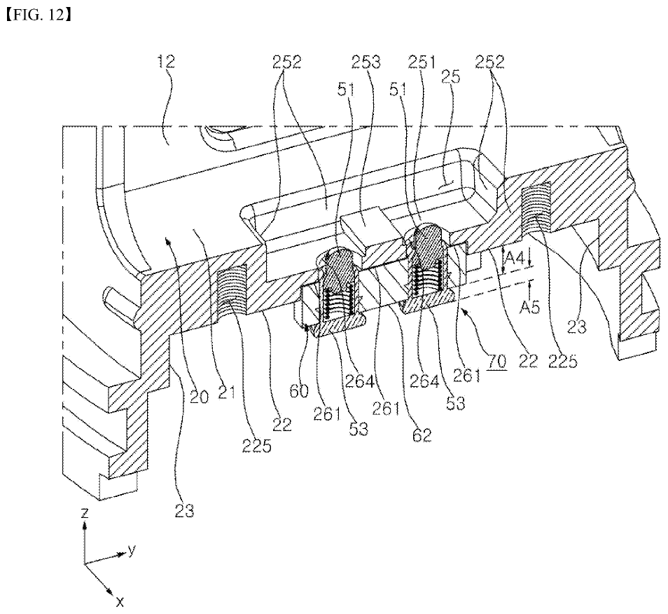

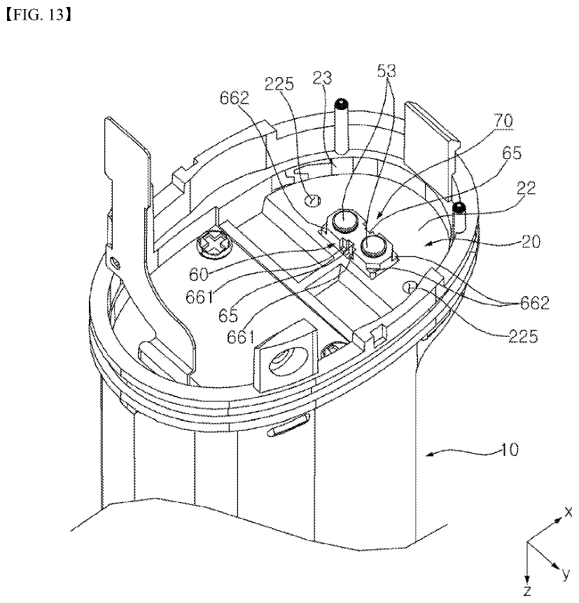

Referring to FIGS. 12 and 13, the pin assembly 70 may be disposed on, in contact with, or coupled to the lower side of the seating part 20. At least a portion of the first molding member 60) may be inserted into the inner recessed groove 26. The top plunger 51 of the first pin 50 may be inserted into the pinhole 264. The top plunger 51 may penetrate through the pinhole 264 to be exposed or protrude to the outer recessed groove 25. The fourth region A4 and the fifth region A5 of the pin assembly 70 may protrude downward of the lower surface 22 of the seating part 20. The upper portion of the first molding member 60 that is disposed in the third region A3 may be inserted into the inner recessed groove 26, and the lower portion of the first molding member 60 that is disposed in the fourth region A4 may protrude downward from the inner recessed groove 26. The upper portion of the first molding member 60 may be supported by the bottom portion 261 and the peripheral portion 262 of the inner recessed groove 26.

Referring to FIGS. 14 and 15, the second molding member 80 may be coupled to the seating part 20) and the first molding member 60. The second molding member 80 may cover or seal between the seating part 20 and the first molding member 60. The second molding member 80 may fill a gap between the first molding member 60 and the seating part 20. The bottom plunger 53 may protrude or be exposed downward of the second molding member 80.

The second molding member 80 may be formed by insert injection molding to cover the gap between the seating part 20 and the first molding member 60. The second molding member 80 may be formed by insert injection molding to cover the lower surface 22 of the seating part 20. For example, the second molding member 80 may be formed by placing, after inserting the first molding member 60 into the inner recessed groove 26, the seating part 20 and the pin assembly 70 in a mold for insert injection molding, injecting a molten injection molding material into the mold, and then cooling and hardening.

The upper portion of the first molding member 60 may be supported by the bottom portion 261 and the peripheral portion 262 of the inner recessed groove 26. A side portion of the first molding member 60 may be joined or coupled to the second molding member 80 to be supported by the second molding member 80.

Accordingly, a liquid, a foreign substance, and the like may be prevented from being introduced, through the pinhole 264, into the aerosol generating device 100. In addition, a liquid, a foreign substance, and the like may be prevented from being introduced into the aerosol generating device 100 through a gap between the first pin 50 and the seating part 20, or the gap between the first molding member 60 and the seating part 20. Further, the first pin 50 may be securely fixed with respect to the seating part 20.

The lower surface 22 of the seating part 20 may be recessed upward to define a first coupling hole 225. The first coupling hole 225 may be formed in the vicinity of the inner recessed groove 26. A plurality of first coupling holes 225 may be arranged in a symmetrical manner with respect to the inner recessed groove 26. A screw thread may be formed on an inner circumferential surface of the first coupling hole 225. The second molding member 80 may be open to define a second coupling hole 85. The second coupling hole 85 may be formed at a position corresponding to the first coupling hole 225 to thereby communicate with the first coupling hole 225. A fastening member 95 (see FIG. 4) protruding upward from the lower body 1 may penetrate through the second coupling hole 85 to be coupled to the first coupling hole 225. The fastening member 95 or a periphery of the fastening member 95 may support the second molding member 80. The fastening member 95 may be a screw. The fastening member 95 may be screwed into the first coupling hole 225.

Accordingly, the upper body 2 and the lower body 1 may be coupled to each other, and the second molding member 80 may be securely fixed or supported.

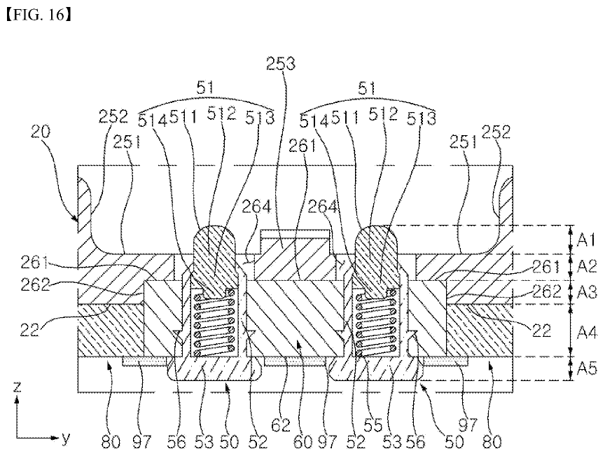

Referring to FIG. 16, in the pin assembly 70, the first region A1 may be disposed at the outer recessed groove 25. The second region A2 may be disposed at the pinhole 264.

The head portion 511 of the top plunger 51 may be disposed at the outer recessed groove 25. The head portion 511 may convexly protrude from the pinhole 264 to the outer recessed groove 25. The head portion 511 may be disposed above, namely, located higher in relation to the bottom portion 251 of the outer recessed groove 25. The head portion 511 may be disposed at the upper side of the second region A2.

The body portion 512 may overlap between the first region A1 and the second region A2, or may be disposed in the second region A2. A height of the body portion 512 exposed to the first region A1 may be lower than a height of the head portion 511. A portion where a curvature of the head portion 511 begins may be adjacent to the second region A2.

Accordingly, when the second pin 47 (see FIG. 3) is brought into contact with the first pin 50, the second pin 47 may slide on the head portion 511 that is curved and press the top plunger 51 downward, making it easier for the first pin 50 and the second pin 47 to be electrically connected to each other. In addition, the cartridge 40 may be prevented from being caught or stuck in the top plunger 51 when the cartridge 40 is mounted on the upper body 2 (see FIG. 3).

The inner recessed groove 26 (see FIG. 10) may be disposed in the third region A3. The fourth region A4 may be disposed on a lower side of the inner recessed groove 26. The upper portion of the first molding member 60 may be recessed into the inner recessed groove 26 to be disposed in the third region A3.

The fourth region A4 may be disposed on a lower side of the lower surface 20 of the seating part 20. The lower portion of the first molding member 60 may protrude or be exposed to the fourth region A4. The second molding member 80 may be disposed in the fourth region A4. The second molding member 80 may cover, at the fourth region A4, the side portion of the first molding member 60. The second molding member 80 may fill or seal, at the fourth region A4, the gap between the first molding member 60 and the seating part 20.

The fifth region A5 may be disposed on a lower side of the second molding member 80. The bottom plunger 53 may be disposed in the fifth region A5. The bottom plunger 53 may protrude or be exposed downward of the second molding member 80. The connector 97 may be disposed in the fifth region A5. The connector 97 may be disposed on the lower side of the second molding member 80. As the connector 97 is connected or coupled to the bottom plunger 53, the connector 97 and the first pin 50 may be electrically connected to each other. The connector 97 may include a connecting hole 974 (see FIG. 4) into which the bottom plunger 53 is inserted.

Accordingly, a liquid, a foreign substance, and the like may be prevented from being introduced, through the pinhole 264, into the aerosol generating device 100. In addition, a liquid, a foreign substance, and the like may be prevented from being introduced into the aerosol generating device 100 through the gap between the first pin 50 and the seating part 20, or the gap between the first molding member 60 and the seating part 20.

Referring to FIG. 17, the first support surface 661 may be disposed in the third region A3 or the fourth region A4. The second support surface 662 may be disposed in the third region A3 or the fourth region A4. The recessed portion 65 may be disposed between the third region A3 and the fourth region A4. The upper portion of the recessed portion 65 may be disposed in the third region A3, and the lower portion of the recessed portion 65 may be disposed in the fourth region A4.

The second molding member 80 may fill the recessed portion 65. The second molding portion 80 that fills the recessed portion 65 may be disposed between the third region A3 and the fourth region A4. The second molding member 80 may be disposed vertically at the recessed portion 65. The second molding member 80 may be coupled, at the recessed portion 65, to the first molding member 60 and the seating part 20.

The second molding member 80 may be coupled to or in close contact with the support surfaces 661 and 662. The support surfaces 661 and 662 may each define a surface in a direction intersecting the up-and-down direction. The second molding member 80 may upwardly support the support surfaces 661 and 662. The second molding member 80 may provide an upward internal force to the support surfaces 661 and 662. The first support surface 661 may be formed adjacent to the first recessed portion 65. The second support surface 662 may be formed adjacent to four corners of the first molding member 60.

Accordingly, the pin assembly 70 may be securely fixed to or supported on the body 3.

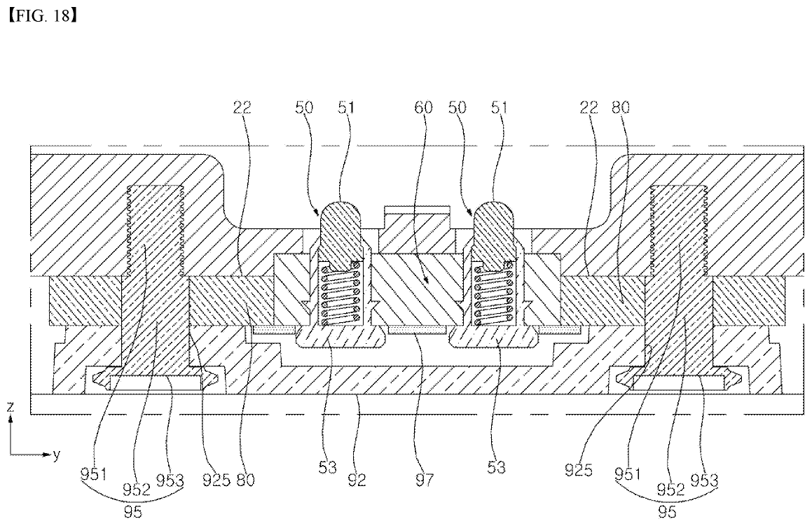

Referring to FIG. 18, a support panel 92 may be disposed on the lower side of the second molding member 80. The support panel 92 may cover or support the lower side of the second molding member 80. The connector 97 may be disposed between the first molding member 60 and the support panel 92.

The support panel 92 may be open to define a third coupling hole 925. The third coupling hole 925 may be formed at a position corresponding to the second coupling hole 85. The third coupling hole 925 may be provided in plurality. The third coupling hole 925 may communicate with the second coupling hole 85.

The fastening member 95 may penetrate through the third coupling hole 925 and the second coupling hole 85 to be fastened to the first coupling hole 225. The fastening member 95 may fix the support panel 92 at a periphery of the third coupling hole 925. The second molding member 80 may be supported or fixed between the lower surface 22 of the seating part 20 and the support panel 92.

The fastening member 95 may include a thread 951. The fastening member 95 may include a shank 952. The fastening member 95 may include a head 953. The thread 951 may be fastened to a female screw provided on the inner circumferential surface of the first coupling hole 225. The shank 952 may be inserted into the second coupling hole 85 and the third coupling hole 925 to be disposed. The head 953 may protrude radially outward from the shank 952. A center of the head 953 may coincide with a center of the shank 952 or a center of the thread 951, and may be greater in circumference than the shank 952 or the thread 951. The head 953 may be disposed on a lower side of the support panel 92, or may support the lower side of the support panel 92. As the support panel 92 is supported by the head 953, a position of the support panel 92 may be fixed to thereby prevent its separation.

Accordingly, the second molding member 80 may be prevented from being separated from the seating part 20. In addition, the second molding member 80 may be protected from the outside, and structural stability of the second molding member 80 may be improved.

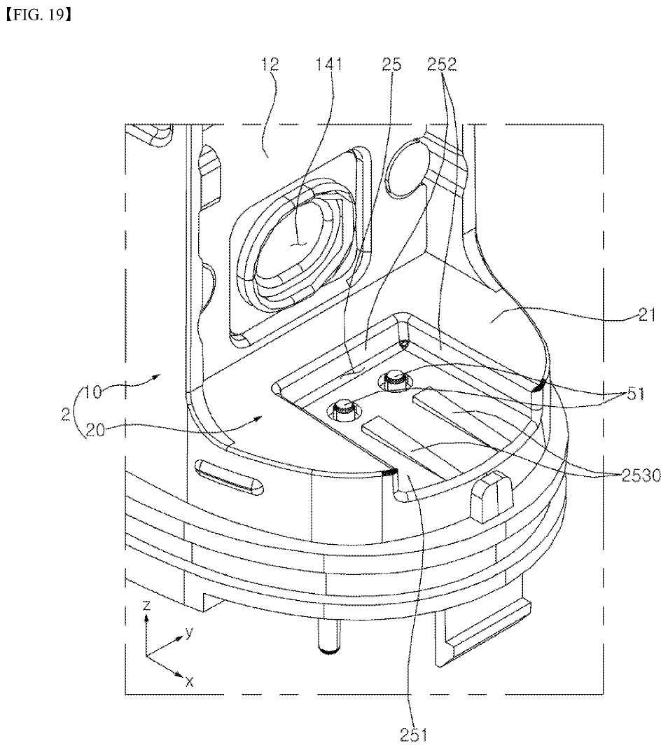

Referring to FIG. 19, a guide portion 2530 may be provided in plurality. The guide portion 2530 may extend long from the front to the rear. The guide portion 2530 may be inclined such that the guide portion 2530 becomes steeper toward the rear. The plurality of guide portions 2530 may be disposed at the front of the plurality of first pins 50, respectively. A height of a rear end of the guide portion 2530 adjacent to the first pin 50 may be the same as or similar to a height of the first pin 50.

Accordingly, when the cartridge 40 (see FIG. 3) is coupled to the upper body 2, the guide portion 2530 may guide placement of the cartridge 40 to allow the first pin 50 and the second pin 47 to be in contact with each other.

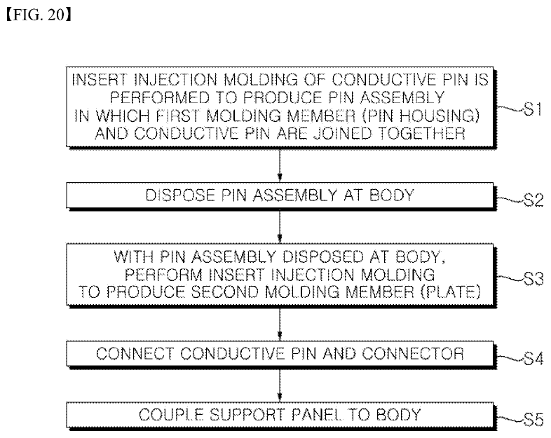

Referring to FIG. 20, insert injection molding of the first pin 50 may be performed to produce the pin assembly 70 in which the first molding member and the first pin 50 are coupled or joined together (S1). Then, the pin assembly 70 may be disposed at the body 3 (S2). In step S2, the pin assembly 70 may be inserted into the inner recessed groove 26. The upper portion of the first molding member 60 may be inserted into the inner recessed groove 26 to be supported by the bottom portion 261 and the peripheral portion 262. The first pin 50 may penetrate through the pinhole 264 of the body 3 to protrude outside the body 3.

With the pin assembly 70 disposed at the body 3, insert injection molding may be performed to produce the second molding member 80 (S3). In step S3, a molten injection molding material is injected, around the pin assembly 70, into the inner surface of the body 3 to be cooled and hardened, thereby forming the second molding member 80. The second molding member 80, together with the pin assembly 70, may be coupled or joined to the inner surface of the body 3. The second molding member 80 may block, fill, or seal a gap between the first molding member 60 and the body 3. The bottom plunger 53 of the first pin 50 may protrude or be exposed from the second molding member 80.

Then, the first pin 50 and the connector 97 may be connected to each other (S4). The connector 97 may be connected to the battery. The connector 97 may provide an electrical connection between the battery and the first pin 50. The bottom plunger 53 that is exposed from the second molding member 80 may be in contact with the connector 97 at an outside of the second molding member 80.

Then, the support panel 92 may be coupled to the body 3 (S5). In step S5, the second molding member 80 may be disposed between the body 3 and the support panel 92. In step S5, the support panel 92 may be fastened, through the fastening member 95, to the body 3 to be fixed. In step S5, the support panel 92 may cover the second molding member 80. The second molding member 80 may be supported by the support panel 92.

Referring to FIGS. 1 to 20, according to one aspect of the present disclosure, there is provided an aerosol generating device 100 including: a body 3 having a pinhole 264; a pin 50 coupled to a pin housing 60 and configured to provide electrical power for generating the aerosol, wherein the pin housing 60 is disposed adjacent to the pin hole 264 such that the pin 50 is inserted through the pin hole 264 toward an outside of the body 3; and a plate 80 coupled to the pin housing 60 and the body 3 and configured to seal a connection between the body 3 and the pin housing 60.

According to another aspect of the present disclosure, the body 3 may comprise an inner recessed groove 26 formed by recessing an inner surface of the body 3 at a periphery of the pinhole 264. The pin housing 60 may be secured in inner recessed groove 26.

According to another aspect of the present disclosure, a portion of the pin housing 60 may protrude from the inner recessed groove 26. The plate 80 may be coupled to the portion of the pin housing 60 that protrudes from the inner recessed groove 26.

According to another aspect of the present disclosure, the pin housing 60 may comprise at least one groove formed by recessing a side portion 611 and a side portion 612 of the pin housing 60, and wherein the plate is configured to engage with the at least one groove.

According to another aspect of the present disclosure, pin housing 60 may comprise a downward facing support surface 661 corresponding to recessed groove at s side portion of the pin housing 60. The plate 80 may be configured to engage with the groove and the support surfaces 661 and 662.

According to another aspect of the present disclosure, the pin 50 may be a pogo pin 50.

According to another aspect of the present disclosure, the pin 50 may include: a curved top plunger 51 inserted through the pinhole 264 and protruding toward the outside of the body 3; a barrel 52 into which the top plunger 51 is inserted and joined and coupled to the pin housing 60; a spring disposed in the barrel 52, and having one side supporting the top plunger 51 and another side contacting a bottom of the barrel 52; and a bottom plunger 53 disposed at the barrel 52 opposite the top plunger 51 and exposed from the pin housing 60 and the plate 80.

According to another aspect of the present disclosure, a lower end of a curved portion of the top plunger 51 may be in contact with or adjacent to the pinhole 264.

According to another aspect of the present disclosure, the aerosol generating device 100 may further include a connector 97 disposed at a lower side of the plate 80 and electrically connected to the bottom plunger 53.

According to another aspect of the present disclosure, the body 3 may further include an outer recessed groove 25 configured to receive a portion of a cartridge 40 inserted therein.

According to another aspect of the present disclosure, the body 3 may further include a guide portion (253, 2530) protruding from a bottom of the outer recessed groove 25 and configured to guide placement of the cartridge 40.

According to another aspect of the present disclosure, the outer recessed groove is configured to allow the portion of the cartridge to be slidably inserted therein. The guide portion (253, 2530) may eleongated and inclined along a sliding direction of the cartridge.

According to another aspect of the present disclosure, the pin 50 and the guide portion 2530 may each be provided in plurality at positions corresponding to each other.

According to another aspect of the present disclosure, the body and the plate are secured together using a fastening member passing through a first coupling hole and a second coupling hole of the body and the plate, respectively.

According to another aspect of the present disclosure, the aerosol generating device 100 may further include a support panel supporting the plate 80. the support panel comprises a third coupling hole through which the fastening member may pass to secure the support panel to the body and plate.

According to another aspect of the present disclosure, the pin housing 60 may be formed by insert injection molding surrounding the pin 50.

According to another aspect of the present disclosure, the plate 80 may be formed by insert injection molding after the pin housing 60 and the body 3 are brought into contact with each other.

According to another aspect of the present disclosure, the plate 80 may be integrally formed with the body 3 and the pin housing 60 but have a boundary that divides the body 3 and the pin housing 60.

According to another aspect of the present disclosure, a material of the plate 80 may fill a gap between the body 3 and the pin housing 60.

According to another aspect of the present disclosure, the aerosol generating device 100 may further include a cartridge 40 configured to store a liquid therein and configured to be coupled to one side of the body 3, and the cartridge 40 may be electrically connected to the pin 50 based on being coupled to the body 3.

Certain embodiments or other embodiments of the disclosure described above are not mutually exclusive or distinct from each other. Any or all elements of the embodiments of the disclosure described above may be combined with another or combined with each other in configuration or function.

For example, a configuration “A” described in one embodiment and/or drawings may be combined with a configuration “B” described in another embodiment and/or drawings. Namely, although the combination between the configurations is not directly described, the combination is possible except in the case where it is described that the combination is impossible.

Although embodiments have been described with reference to a number of illustrative embodiments thereof, it should be understood that numerous other modifications and embodiments can be devised by those skilled in the art that will fall within the scope of the principles of this disclosure. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

1. An aerosol generating device comprising:
a body comprising a pin hole;
a pin coupled to a pin housing and configured to provide electrical power for generating the aerosol, wherein the pin housing is disposed adjacent to the pin hole such that the pin is inserted through the pin hole toward an outside of the body; and
a plate coupled to the pin housing and the body and configured to seal a connection between the body and the pin housing.

2. The aerosol generating device of claim 1, wherein the body comprises an inner recessed groove formed by recessing an inner surface of the body at a periphery of the pinhole, and wherein the pin housing is secured in the inner recessed groove.

3. The aerosol generating device of claim 2, wherein a portion of the pin housing protrudes from the inner recessed groove, and
wherein the plate is coupled to the portion of the pin housing that protrudes from the inner recessed groove.

4. The aerosol generating device of claim 1, wherein the pin housing comprises at least one groove formed by recessing a side portion of the pin housing, and wherein the plate is configured to engage with the at least one groove.

5. The aerosol generating device of claim 1, wherein the pin housing comprises a downward facing support surface corresponding to a recessed groove at a side portion of the pin housing, and
wherein the plate is configured to engage with the groove and the support surface.

6. The aerosol generating device of claim 1, wherein the pin is a pogo pin.

7. The aerosol generating device of claim 6, wherein the pin comprises:
a curved top plunger inserted through the pinhole and protruding toward the outside of the body;
a barrel into which the top plunger is inserted, the barrel being coupled to the pin housing;
a spring disposed in the barrel and having one side supporting the top plunger and another side contacting a bottom of the barrel; and
a bottom plunger disposed at the barrel opposite the top plunger and exposed from the pin housing and the plate.

8. The aerosol generating device of claim 7, wherein a lower end of a curved portion of the top plunger is in contact with or adjacent to the pinhole.

9. The aerosol generating device of claim 7, further comprising a connector disposed at a lower side of the plate and electrically connected to the bottom plunger.

10. The aerosol generating device of claim 1, wherein the body and the plate are secured together using a fastening member passing through a first coupling hole and a second coupling hole of the body and the plate, respectively.

11. The aerosol generating device of claim 10, further comprising a support panel supporting the plate,
wherein the support panel comprises a third coupling hole through which the fastening member passes to secure the support panel to the body and plate.

12. The aerosol generating device of claim 1, wherein the pin housing is formed by insert injection molding surrounding the pin.

13. The aerosol generating device of claim 1, wherein the plate is formed by insert injection molding after the pin housing and the body are brought into contact with each other.

14. The aerosol generating device of claim 1, wherein a material of the plate fills a gap between the body and the pin housing.

15. The aerosol generating device of claim 1, further comprising a cartridge configured to store a liquid therein and configured to be coupled to one side of the body, wherein the cartridge is electrically connected to the pin based on being coupled to the body.
